(19) United States
(12) Patent Application Publication
(10) Pub. No.: US 2024/0177372 A1
(43) Pub. Date: May 30, 2024

(54) SYSTEMS AND METHODS OF REPRESENTING PHRASES WITH PALETTES

(71) Applicant: Perception Systems, LLC, Irvine, CA (US)

(72) Inventors: Mitchell Pudil, Bountiful, UT (US); Michael Blum, Bountiful, UT (US); Jamison Moody, Provo, UT (US); Michael Henry Merchant, Rancho Santa Margarita, CA (US); Danny Petrovich, La Habra Height, CA (US)

(21) Appl. No.: 18/521,639

(22) Filed: Nov. 28, 2023

Related U.S. Application Data
(60) Provisional application No. 63/385,180, filed on Nov. 28, 2022.

(51) Int. Cl. G06T 11/00

(52) U.S. Cl. CPC G06T 11/001

(57) ABSTRACT

Systems and methods for representing phrases with palettes are disclosed. The system may include a processor, a memory communicatively coupled to the processor, and a logic. The logic can receive a phrase, generate a set of vectors associated with each identified words in the phrase, calculate a first overall vector associated with the received phrase based on a vector summation of the generated set of vectors, generate a palette for a set of colors including a predefined number of colors, and calculate a second overall vector associated with the palette based on a vector summation of the set of colors. The logic can further store the generated palette in response to a determination that a closeness ratio associated with the generated palette is larger than a predetermined threshold. The closeness ratio is defined as an inverse of a difference between the calculated overall vectors.

### PRIORITY

This application claims the benefit of and priority to U.S. Provisional Application, entitled “Systems and Methods of Representing Phrases With Palettes,” filed on Nov. 28, 2022 and having application Ser. No. 63/385,180.

### FIELD

The present disclosure relates to natural language processing systems. More particularly, the present disclosure relates to representing an phrase by a palette.

### BACKGROUND

Current natural language techniques often output a class label for an identified word. Commercial brands and other users are often competing to have an upper hand against their competitors. On one hand, businesses spend heavily to design brands and logos that are appealing to their customers and make them various emotions (such as “feeling good”) about the brand or user. On the other hand, changing color schemes of brands can be expensive, so picking the wrong colors in the brands that are associated with or generate negative responses can cause headaches to the business owners and/or users.

### SUMMARY

According to an aspect of the present disclosure, a device for representing a phrase with a palette is disclosed. The device includes a processor, a memory communicatively coupled to the processor, and a logic. The logic can receive a phrase, generate a set of vectors associated with each identified words in the phrase, calculate a first overall vector associated with the received phrase based on a vector summation of the generated set of vectors, generate a palette for a set of colors comprising a predefined number of colors, and calculate a second overall vector associated with the palette based on a vector summation of the set of colors. In some embodiments, and in response to a first determination that a first closeness ratio associated with the generated palette is larger than a first predetermined threshold, the logic can store the generated palette. The first closeness ratio can be defined as an inverse of a difference between the calculated first overall vector and the calculated second overall vector. In an embodiment, the logic can display the generated palette to a user, which can transmit the phrase and can select the predefined number of colors.

In some embodiments, the logic can access portions of a color spectrum including data of colors that are visible to human eye, and generate the palette for the set of colors comprising the pre-defined number of colors based on the accessed portions. The logic can further parse the received phrase to identify the words.

In an embodiment, the logic can access a database comprising pairs of colors and corresponding adjectives, and determine an adjective for each of the set of colors of the generated palette. The logic can further receive a set of words, assign a weight between zero and one to each of the received words, generate a second set of vectors associated with each of the received words, calculate a set of weighted vectors by applying the assigned weight to the associated received word, and calculate a third overall vector associated with the received set of words based on the vector summation of the calculated set of weighted vectors.

The logic can store the palette in response to a second determination that a second closeness ratio associated with the generated palette is larger than a second predetermined threshold. The second closeness ratio is defined as an inverse of a difference between the calculated second overall vector and the calculated third overall vector. In an embodiment, the user selects the assigned weights. In several embodiments, the logic includes one or more artificial intelligence models including at least one of: a convolutional neural network, a region-based convolutional neural network, and a You Only Look Once neural network. The one or more artificial intelligence models can at least: generate the set of vectors associated with each identified words in the phrase, calculate the first overall vector and the second overall vector, generate the palette for the set of colors comprising the predefined number of colors, and determine whether the closeness ratio associated with the generated palette is larger than the predetermined threshold.

According to another aspect of the present disclosure, a method to represent a phrase with a palette is disclosed. The method can include receiving a phrase, generating a set of vectors associated with each identified words in the phrase, calculating a first overall vector associated with the received phrase based on a vector summation of the generated set of vectors, generating a palette for a set of colors comprising a predefined number of colors, calculating a second overall vector associated with the palette based on a vector summation of the set of colors. The method can further include storing the palette in response to a first determination that a first closeness ratio associated with the generated palette is larger than a first predetermined threshold. The first closeness ratio is defined as an inverse of a difference between the calculated first overall vector and the calculated second overall vector.

The method can include accessing portions of a database including data of colors that are visible to human eye, and generating the palette for the set of colors comprising the pre-defined number of colors based on the accessed portions. The method can further include parsing the received phrase to identify the words, and accessing a database comprising pairs of colors and corresponding adjectives, and determining an adjective for each of the set of colors of the generated palette.

In some embodiments, the method can include receiving a set of words, assigning a weight between zero and one to each of the received words, generating a second set of vectors associated with each of the received words, calculating a set of weighted vectors by applying the assigned weight to the associated received word, and calculating a third overall vector associated with the received set of words based on the vector summation of the calculated set of weighted vectors.

In an embodiment, the method can include storing the palette in response to a second determination that a second closeness ratio associated with the generated palette is larger than a second predetermined threshold. The second closeness ratio is defined as an inverse of a difference between the calculated second overall vector and the calculated third overall vector. In an embodiment, the method can further include utilizing one or more artificial intelligence models including at least one of: a convolutional neural network, a region-based convolutional neural network, and a You Only Look Once neural network to perform at least: generating the set of vectors associated with each identified words in the phrase, calculating the first overall vector and the second overall vector, generating the palette for the set of colors comprising the predefined number of colors, and determining whether the closeness ratio associated with the generated palette is larger than the predetermined threshold.

According to yet another aspect of the present disclose, a phrase to palette representation system is disclosed. The system can include one or more word to palette representation devices, one or more processors coupled to the one or more word to palette representation devices, and a non-transitory computer-readable storage medium for storing instructions that, when executed by the one or more processors, direct the one or more processors to: receive a phrase, generate a set of vectors associated with each identified words in the phrase, calculate a first overall vector associated with the received phrase based on a vector summation of the generated set of vectors, generate a palette for a set of colors comprising a predefined number of colors, calculate a second overall vector associated with the palette based on a vector summation of the set of colors, and in response to a first determination that a first closeness ratio associated with the generated palette is larger than a first predetermined threshold, store the generated palette. The first closeness ratio is defined as an inverse of a difference between the calculated first overall vector and the calculated second overall vector.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a system for representing a phrase with a palette 100 in accordance with some embodiments of the disclosure;

FIG. 2 is a conceptual diagram of a palette generated by the logic in accordance with some embodiments of the disclosure;

FIG. 3 is a conceptual diagram of a set of adjectives generated by the logic in accordance with some embodiments of the disclosure;

FIG. 4 is a conceptual diagram of generating a palette associated with a phrase in accordance with an embodiment of the disclosure;

FIG. 5 is a flowchart depicting a process for storing a pair of color-adjective in accordance with an embodiment of the disclosure;

FIG. 6 is a flowchart depicting a process for generating a palette for a phrase in accordance with an embodiment of the disclosure;

FIG. 7 is a conceptual diagram of a device configured to utilize a phrase to palette representation logic in accordance with various embodiments of the disclosure; and

FIG. 8 is a conceptual network diagram of various environments that a phrase to palette representation logic may operate within in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems described above, systems and methods are discussed herein that can efficiently represent a phrase with a palette including a plurality of colors. A user can input the phrase and the system can generate a palette based on the words in the phrase. In many embodiments, the system can associate each word of the phrase with high-dimensional vectors and generate the palette based on vector calculations. In many embodiments, the system can enable the user to select one or more colors which then will be used by the system to generate the palette.

Additionally, in a variety of embodiments, the system can utilize artificial intelligence models to achieve the end goal. That is, the artificial intelligence models can perform some or all of the steps that described herein. Various artificial intelligence models can be used, and the system can train the artificial intelligence models to perform such steps in an efficient manner and with enhanced accuracy.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to”, unless expressly specified otherwise. An enumerated listing of items does not imply that any or all of the items are mutually exclusive and/or mutually inclusive, unless expressly specified otherwise. The terms “a.” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

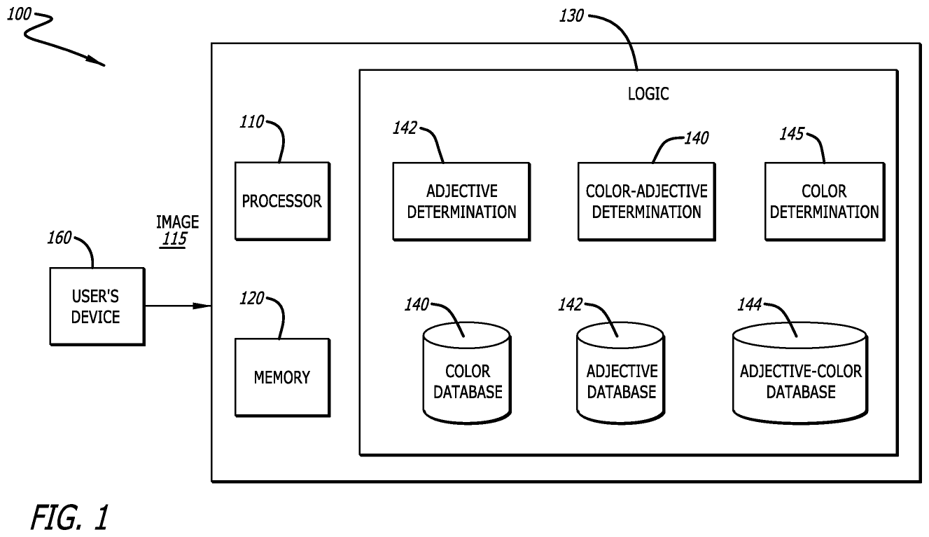

Referring to FIG. 1, a schematic block diagram of a system for representing a phrase with a palette 100 in accordance with some embodiments of the disclosure, is shown. The system for representing a phrase with a palette 100 can include a processor 110, a memory 120 communicatively coupled to the processor 110, and a logic 130. The logic 130 can include an adjective determination unit 142, a color-adjective determination unit 145, and a color determination unit 145. The logic 130 can further include one or more databases including a color database 154, an adjective database 152 and an adjective-color database 144. In many embodiments, the adjective determination unit 142, the color-adjective determination unit 145, the color determination unit 145, the adjective determination unit 138, the color-adjective determination unit 145, the color database 154, the adjective database 152 and the adjective-color database 144 are in communication with each other. Although the logic 130 as illustrated in FIG. 1, includes separate adjective determination unit 142, color-adjective determination unit 145, and color determination unit 145, in some embodiments, one unit can perform functions of two or more other units. For example, the adjective determination unit 142 can perform the color detection and object detection tasks. Similarly, although three separate databases are illustrated in FIG. 1, the logic 130 can include any number of databases. For example, in an embodiment, the logic 130 can include one database including colors, adjectives and adjective-color pairs. In some embodiments, the system for representing an image with a palette 100 can communicate with a user device 160. The user device 160 can be any suitable user device capable of communicating with the logic 130. For example, the user device 160 can be a desktop PC, a laptop, a smartphone, etc. The user device 160 can transmit the phrase 115 to the system for representing a phrase with a palette 100. The system for representing a phrase with a palette 100 can further include a communication interface (not shown). The processor 110 may include one or more central processing units, one or more general-purpose processors, one or more application-specific processors, one or more virtual processors, one or more processor cores, or the like.

In some embodiments, the system for representing a phrase with a palette 100 can receive a phrase 115. The phrase 115 can be transmitted via a user's device 160 in communication with the system for representing a phrase with a palette 100. As noted above, the user device 160 can be any suitable device capable of communicating with the logic 130. The logic 130 can process the phrase 115 to generate a palette representing the phrase 115. The process of generating the palette representing the phrase is described in details below.

It should be noted that, in various embodiments, the system for representing a phrase with a palette 100 can utilize one or more artificial intelligence models to perform any of the steps of the process of generating the palette representing the phrase as disclosed herein. The artificial intelligence models can include any of the commercially available artificial intelligence models that are specially trained to perform any of the steps described below. It should be noted that, although not expressly specified, any software, algorithm or model described herein can include a trained artificial intelligence algorithm.

The system for representing a phrase with a palette 100, or the adjective determination unit 142 of the logic 130, can identify one or more words in the phrase. To that end, the logic 130 can parse the phrase to identify the one or more words in the phrase. In an embodiment, the logic 130 can identify and remove any special characters. The special characters can include punctuations (e.g., question marks, quotation marks, apostrophes, etc.). In an embodiment, the logic 130 can tokenize separate text into words. As a non-limiting example, the phrase “appealing and modern” can be tokenized into “appealing” and “modern” words. In an embodiment, the logic 130 can stem the identified words by performing a morphological analysis to find the root word. As another non-limiting example, when an identified word is “entitling”, the logic 130 can use a dictionary-based approach and replace the “entitling” with “entitle”.

In some embodiments, the logic 130 can generate a vector associated with each of the identified words. Each vector may be represented as a combination of direction and magnitude. The logic 130 can further calculate a first overall vector associated with the received phrase based on a vector summation of the generated vectors. In various embodiments, in order to calculate the sum of two vectors, the logic 130 can place the vectors so the first end of both vectors, i.e., the origins of vectors, are located at a common point. The logic 130 then can add the vectors based on conventional vector summation formula, e.g., parallelogram law, to calculate the first overall vector.

According to some embodiments of the present disclosure, the system for representing a phrase with a palette 100, or the color determination unit 145 of the logic 130, can access the color database 140. For example, the color database 140 can include a color spectrum. The color spectrum can include at least color data that is visible to human eye. However, it should be noted, the color spectrum can include color data that is not visible to human eye. As a non-limiting example, the color spectrum may include color data attributed to infra-red portion of the color spectrum and/or ultra-violet portion of the color spectrum. The color database can be stored in the system for representing a phrase with a palette 100. Alternatively, the system for representing a phrase with a palette 100 can access a remote color database which is located outside the system for representing a phrase with a palette 100.

The logic 130 can select a set of colors from the color database 154. The logic 130 or a user can select the number of colors in the set of colors. However, in various embodiments, the set of colors can include at least two colors. The logic 130 can further generate a palette for each set of colors and then calculate a second overall vector for each of the sets of colors. As noted above, to calculate the sum of the vectors, the logic 130 can place the vectors so the origins of vectors are located at a common point. The logic 130 then can add the vectors based on conventional vector summation formula to calculate the second overall vector.

The logic 130 can determine whether a generated palette is a suitable representative of the phrase. To that end, for each second overall vector, the logic 130 can calculate a first closeness ratio. The first closeness ratio can be a mathematical formula to quantifiably correlate the first overall vector and the second overall vector, which can be used to determine the set of colors, i.e., palettes, that most “closely” represent the phrase. Thus, the first closeness ratio can be defined as an inverse of a difference between the calculated first overall vector and the calculated second overall vector.

Once the logic 130 calculates the inverse of the difference between the first overall vector and the second overall vector for each palette, i.e., the first closeness ratio, the logic 130 can determine whether or not the first closeness ratio exceeds a certain threshold, first threshold. If the answer is yes and the first closeness ratio for the palette exceeds the first threshold, then the logic 130 can store the palette. Otherwise, if the first closeness ratio does not exceed the first threshold, then the logic 130 can discard the palette. In various embodiments, the first threshold can be determined by the user or the system for representing an phrase with a palette 100. For example, the first threshold can be defined as a percentage (e.g., above 80%). In some embodiments, in response to a determination that none of the palettes satisfies the requirement (i.e., none of the palettes has a first closeness ratio that exceeds the first threshold), the logic 130 can increase the first threshold or request the user to increase the first threshold. Additionally, in some embodiments, in response to a determination that multiple palettes satisfy the requirement (i.e., multiple palettes have first closeness ratios that exceed the first threshold), the logic 130 can decrease the first threshold or request the user to decrease the first threshold. The logic 130 can further sort the palettes based on their respective first closeness ratios and display a pre-defined number of palettes to the user with the highest first closeness ratio. The logic 130 can further display the palettes to the user.

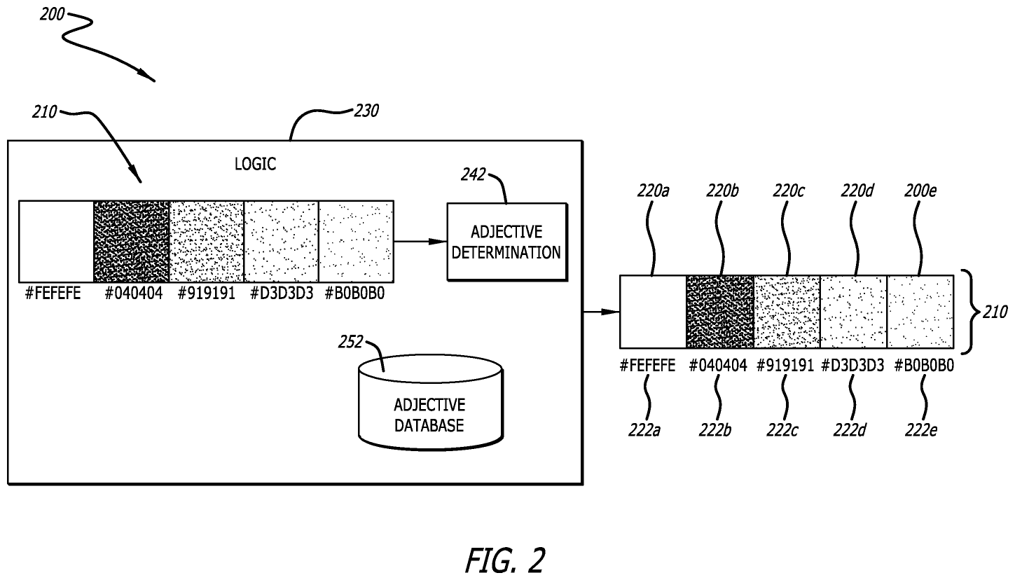

Although a specific embodiment for a schematic block diagram of a system for representing an image with a palette suitable for carrying out the various steps, processes, methods, and operations described herein is discussed with respect to FIG. 1, any of a variety of systems and/or processes may be utilized in accordance with embodiments of the disclosure. For example, the image to palette representation logic may be implemented across a variety of the systems described herein such that some representations are generated on a first system type (e.g., remotely), while additional steps or actions are generated or determined in a second system type (e.g., locally). The elements depicted in FIG. 1 may also be interchangeable with other elements of FIGS. 2-8 as required to realize a particularly desired embodiment.

Referring to FIG. 2 now, a conceptual diagram 200 of palette 210 generated by the phrase to palette representation logic 230 (shown as “logic”) is shown, according to some embodiments. As noted above, the phrase to palette representation logic 230 can generate the palette based on the calculated set of phrases or phrase or other portion of input data. The palette can include a set of colors 220a, 220b, 220c, 220d and 220e. While the palettes 210 shown in FIG. 2 includes 5 colors, it should be noted that the palette can include any number of colors. The palette 210 can further include metadata associated with each color. For example, the palette 210 can include identifying color codes 222a, 222b, 222c. 222d and 222e associated with each color 220a, 220b, 220c, 220d and 220e, as shown in FIG. 2.

Each vector may be represented as a combination of direction and magnitude. In various embodiments, in order to calculate the sum of two vectors, the system for representing an image with a palette 210 can place the vectors so the first end of both vectors, i.e., the origins of vectors, are located at a common point. The system for representing an image with a palette 210 then can add the vectors based on conventional vector summation formula, e.g., parallelogram law, to calculate each of the set of overall vectors. The system for representing an image with a palette 210 can further sort the set of overall vectors based on their respective length. In other words, by combining the cross sections of the areas that comprise each color, the system for representing an image with a palette 210 is able to determine the dominant color(s), accent color(s) and secondary color(s) by sorting the summations of lengths of vectors associated with each color. Thus, for example, when color A is the dominant color in the image, and color B is the secondary color, then the vector associated with the color A has a higher length than the vector associated with the color B.

In some embodiments, the system for representing an image with a palette 210 can display a pre-defined number of colors to the user based on the lengths of the vectors associated with the colors. The user may be able to determine the pre-defined number prior to displaying the colors. Additionally, the system for representing an image with a palette 210 can select the pre-defined number of colors and generate a palette including the pre-defined number of colors. Subsequently, the system for representing an image with a palette 210 can display the palette to the user.

The system for representing an image with a palette 210 may generate more than one palette. As a non-limiting example, the image may include multiple dominant colors. In such instances, the pre-defined number of colors that is included in the generated palette may be insufficient to show every dominant color. As another non-limiting example, the image may include several colors, with no dominant colors. In yet another non-limiting example, the user may request additional colors to be shown and/or suggested in the palette. In such instances, the palette may not be able to display all the dominant colors, each of the several colors, or the requested colors, respectively. Thus, additional palettes may be needed to be generated. In response to such instances, the system for representing an image with a palette 210 can generate additional palettes. Each additional palette should satisfy a condition which is how close the vectors associated with such additional palette and the image are. Therefore, the system for representing an image with a palette 210 can generate the additional palette based on a closeness ratio between the overall vector associated with the additional palette and the overall vector associated with the image.

To that end, the system can define the closeness ratio based on a suitable mathematical formula. In some embodiments, the closeness ratio is defined as an inverse of a difference between the overall vector associated with the palette and the vector associated with the image. The system for representing an image with a palette 210 can then identify a set of colors that may be possible candidates to form the additional palette (e.g., colors selected by the user, dominant color not included in the first generated palette, etc.). The system for representing an image with a palette 100 then calculates the overall vector associated with the possible additional palette. The system for representing an image with palette 210 can calculate the inverse of the difference between the vector associated with the image and the vector associated with the possible additional palette, i.e., the closeness ratio. If the closeness ratio exceeds a certain threshold, then the system for representing an image with a palette 210 can store the possible additional palette as an additional palette. Otherwise, if the closeness ratio does not exceed the threshold, then the system for representing an image with a palette 210 can discard the possible additional palette. In various embodiments, the threshold can be determined by the user or the system for representing an image with a palette 210. For example, the threshold can be defined as a percentage (e.g., above 80%). In some embodiments, in response to a determination that none of the possible additional palettes satisfies the requirement (i.e., none of the possible additional palettes has a closeness ratio that exceeds the threshold), the system for representing an image with a palette 210 can increase the threshold or request the user to increase the threshold. Additionally, in some embodiments, in response to a determination that multiple possible additional palettes satisfy the requirement (i.e., multiple possible additional palettes have closeness ratios that exceed the threshold), the system for representing an image with a palette 210 can decrease the threshold or request the user to decrease the threshold. The system for representing an image with a palette 210 can further sort the additional palettes based on their respective closeness ratios and display a pre-defined number of additional palettes to the user with the highest closeness ratio.

Although a specific embodiment for a conceptual diagram of palette generated by system for representing an image with a palette suitable for carrying out the various steps, processes, methods, and operations described herein is discussed with respect to FIG. 2, any of a variety of systems and/or processes may be utilized in accordance with embodiments of the disclosure. For example, image codes may be hexadecimal, but may be any identification data that can be equated with a specific shade/color. The elements depicted in FIG. 2 may also be interchangeable with other elements of FIGS. 1 and 3-8 as required to realize a particularly desired embodiment.

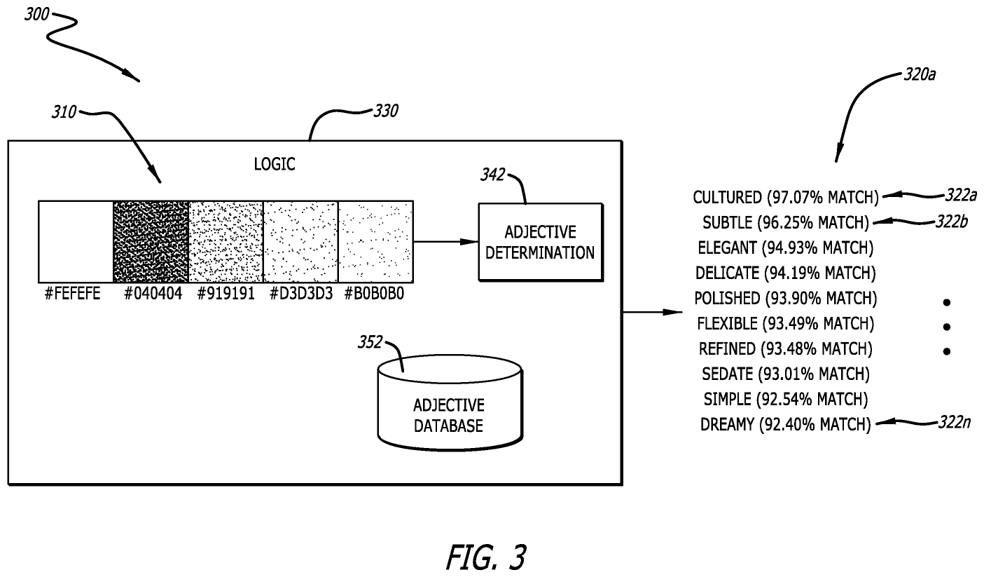

Referring to FIG. 3, a conceptual diagram of a set of adjectives generated by the logic 300 in accordance with some embodiments of the disclosure. In some embodiments, the logic 330 can parse the phrase to identify the one or more words in the phrase, as described above. Parsing the phrase can include logic identifying and removing special characters (e.g., question marks, quotation marks, apostrophes, etc.), tokenizing separate text into words, stemming the identified words by performing morphological analyses to find the root word, etc. The logic 330 can further generate a set of adjectives 320 for the palette. To that end, the adjective determination unit 342 of the logic 330 can access the adjective database 352 to determine the set of adjectives 320. The adjective database 352 can include pairs of colors and corresponding adjectives. Each adjective can be pre-classified with one or more colors in the adjective database 352. In an embodiment, the logic 330 can generate a vector associated with each adjective and store the adjective along with its associated vector in the adjective database 352. The logic 330 can then compare the vectors associated with each adjective and the vector associated with the palette in order to determine the set of adjectives representing the palette 310. The logic 330 can use a match score to determine the set of adjectives 320. Each of the set of adjectives 320 can include an adjective and the corresponding match score 322a, 322b, . . . 322n. In some embodiments, the user can select the number of adjectives. Alternatively, the user can select the closeness ratio and/or the threshold.

The logic 330 can identify a set of words in the phrase and assign a weight to each of the words. The weights can be any number between zero and one. The logic 330 can generate a second set of vectors associated with each of the words and calculate a set of weighted vectors by applying the weights to corresponding words. Utilizing the set of weighted vectors, the logic 330 can calculate a third overall vector associated with the set of words based on a vector summation operation performed on the set of weighted vectors. In some embodiments, in response to a second determination that a second closeness ratio associated with the generated palette is larger than a second predetermined threshold, the logic 330 can store the generated palette. The second closeness ratio can be defined as an inverse of a difference between the calculated third overall vector and the calculated second overall vector. The user can select the assigned weights.

In more embodiments, the methods discussed herein can be translated to more languages besides English. In some embodiments, differences in cultures and/or demographics can be accounted for when generating words, palettes, etc. In additional embodiments, websites and other digital assets can be generated utilizing words and/or palettes described herein. In still more embodiments, the mediums utilized can be expanded to use, for example, audio recordings such as, but not limited to, voice recordings. In a number of embodiments, the conversion may include converting the color or ambient color temperature of an environment can be done, such as, but not limited to, changing color via smart bulbs or Arduino controllers. In certain embodiments, the color of one or more images can be automatically changed based on the generated results.

Although a conceptual diagram of a set of adjectives generated by the logic suitable for carrying out the various steps, processes, methods, and operations described herein is discussed with respect to FIG. 3, any of a variety of systems and/or processes may be utilized in accordance with embodiments of the disclosure. For example, adjectives may be in English, but may be in other languages or a numerical code that can be equated with a specific word. The elements depicted in FIG. 3 may also be interchangeable with other elements of FIGS. 1-2 and 4-8 as required to realize a particularly desired embodiment.

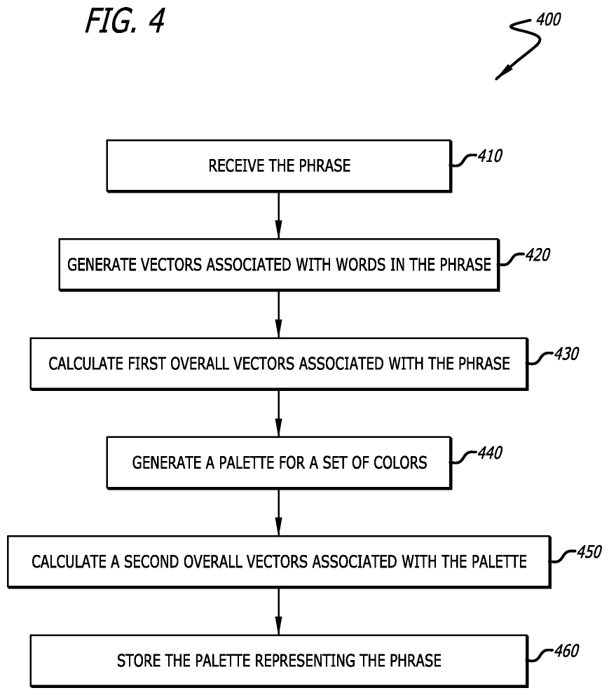

Referring to FIG. 4, a process 400 for generating a palette associated with a phrase in accordance with an embodiment of the disclosure, is shown. In some embodiments, the process 400 can receive the phrase, as shown by block 410. The phrase can be transmitted via a user's device. In various embodiments, the process 400 can generate a set of vectors associated with the words in the phrase, as shown by block 420. Each vector may be represented as a combination of direction and magnitude. In an embodiment, the process 400 can calculate a first overall vector associated with the received phrase based on a vector summation of the generated vectors, as shown by block 430. In various embodiments, the process 400 can place the vectors so the first end of both vectors are located at a common point, and then add the two vectors based on conventional vector summation formula to calculate the first overall vector.

In additional embodiments, the process 400 can generate a palette for a set of colors, as shown by block 440. The process 400 can access at least portions of a color database which includes a color spectrum including at least color data that is visible to human eye. In some embodiments, the process 400 can calculate a second overall vector for each of the sets of colors, as shown by block 450. As noted above, to calculate the sum of the vectors, the process 400 can place the vectors so the origins of vectors are located at a common point and add the vectors based on conventional vector summation formula to calculate the second overall vector. The process 400 can the store the palette representing the phrase, as shown by block 460.

Although a conceptual diagram of generating a palette associated with a phrase suitable for carrying out the various steps, processes, methods, and operations described herein is discussed with respect to FIG. 4, any of a variety of systems and/or processes may be utilized in accordance with embodiments of the disclosure. For example, the vectors in the phrase may be detected via a machine learning process but may be executed by a remote or cloud-based service. The elements depicted in FIG. 4 may also be interchangeable with other elements of FIGS. 1-3 and 5-8 as required to realize a particularly desired embodiment.

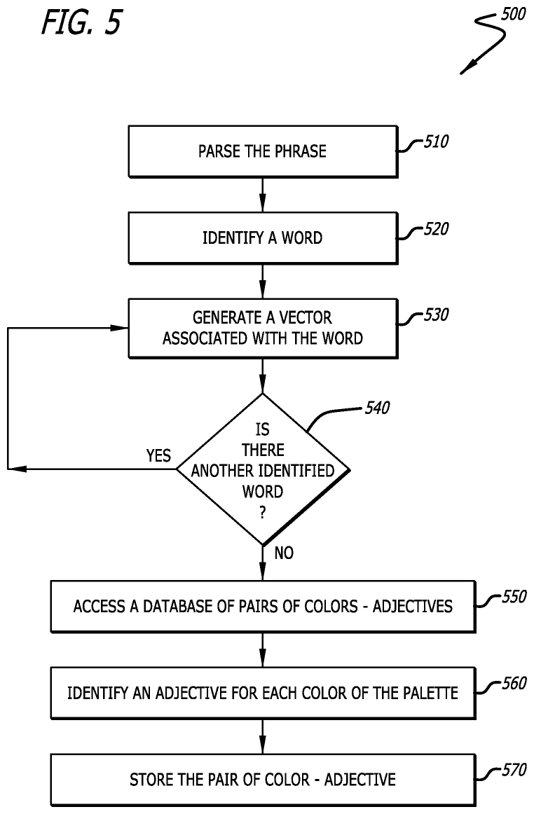

Referring to FIG. 5, a flowchart depicting a process for storing a pair of color-adjective in accordance with an embodiment of the disclosure, is shown. In some embodiments, the process 500 can parse the phrase, as shown by block 510. The process 500 can then identify a word in the phrase, as shown by block 520. The process 500 can proceed to generate a vector associated with the word, as shown by block 530. The process 500 can determine whether there is any additional word in the phrase, as shown by block 540. If there is additional word in the phrase, the process 500 moves back to block 530 where the process 500 can generate a vector associated with the additional word, as shown by block 550. Once the process 500 determines that there is no additional word in the phrase, the process 500 can proceed to access a database of pairs of colors and adjectives, as shown by block 560. The process 500 can then identify an adjective for each color of the palette, as shown by block 570. To that end, the process 500 can access the adjective database that can include pairs of colors and corresponding adjectives, pre-classified with each other. The process 500 can then store the pairs of color and adjective, as shown by block 580.

Although a flowchart depicting a process for storing a pair of color-adjective suitable for carrying out the various steps, processes, methods, and operations described herein is discussed with respect to FIG. 5, any of a variety of systems and/or processes may be utilized in accordance with embodiments of the disclosure. For example, other data associated with a phrase may be analyzed, including synonyms, anonyms, cultural associations, etc. The elements depicted in FIG. 5 may also be interchangeable with other elements of FIGS. 1-4 and 6-8 as required to realize a particularly desired embodiment.

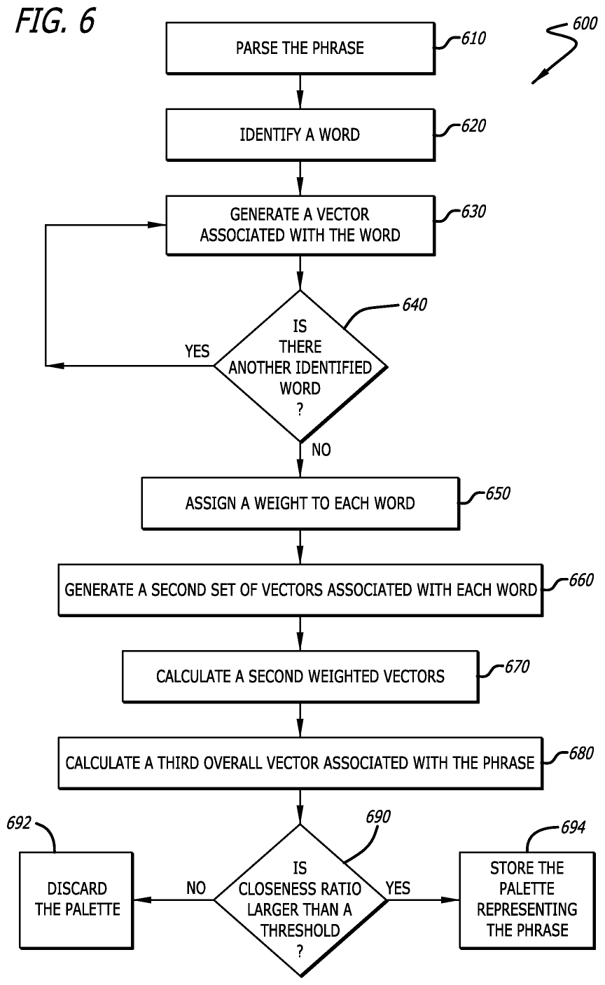

Referring to FIG. 6, a flowchart depicting a process for storing a pair of color-adjective in accordance with an embodiment of the disclosure, is shown. In many embodiments, the process 600 can first parse the phrase, as shown in block 610. In an embodiment, the process 600 can identify a word in the phrase, as shown in block 620. In some embodiments, the process 600 can proceed to generate a vector associated with the word, as shown by block 630. In several embodiments, the process 600 can determine whether there is any additional word in the phrase, as shown by block 640. If there is additional word in the phrase, the process 600 can generate a vector associated with the additional word, as shown by block 650. Once the process 600 determines that there is no additional word in the phrase, the process 600 can proceed to assign a weight to each word, as shown by block 660. The weights can be any number between zero and one. In additional embodiments, the process 600 can proceed to generate a second set of vectors associated with each of the words, as shown by block 670, and calculate a set of weighted vectors by applying the weights to corresponding words, as shown by block 680.

By using the set of weighted vectors, the process 600 can calculate a third overall vector associated with the set of words based on a vector summation of the weighted vectors, as shown by block 690. In some embodiments, the process 600 can proceed to determine whether each of the generated palettes satisfies a condition, as shown in block 692. The condition can be satisfied once a calculated second closeness ratio exceeds a second threshold. To that end, the process 600 can define the second closeness ratio based on a mathematical formula. In some embodiments, the second closeness ratio can be defined as an inverse of a difference between the second overall vector and the third overall vector. If the second closeness ratio does not exceed the second threshold, then the process 600 discards the palette, as shown by block 694. Otherwise, if the second closeness ratio exceeds the second threshold, then the process 600 can store the palette, as shown by block 696.

It should be noted that, one or more artificial intelligence models ca be trained and used to perform at last some of the operations described herein. The artificial intelligence models can include at least one of: a convolutional neural network, a region-based convolutional neural network, and a You Only Look Once neural network. Such artificial intelligence models can perform at least: generating the set of vectors associated with each identified words in the phrase, calculating the first overall vector and the second overall vector, generating the palette for the set of colors comprising the predefined number of colors, and determining whether the closeness ratio associated with the generated palette is larger than the predetermined threshold.

Although a flowchart depicting a process for generating a palette for a phrase suitable for carrying out the various steps, processes, methods, and operations described herein is discussed with respect to FIG. 6, any of a variety of systems and/or processes may be utilized in accordance with embodiments of the disclosure. For example, multiple palettes may be associated with a single adjective or multiple adjectives depending on the culture or other application. The elements depicted in FIG. 6 may also be interchangeable with other elements of FIGS. 1-5 and 7-8 as required to realize a particularly desired embodiment.

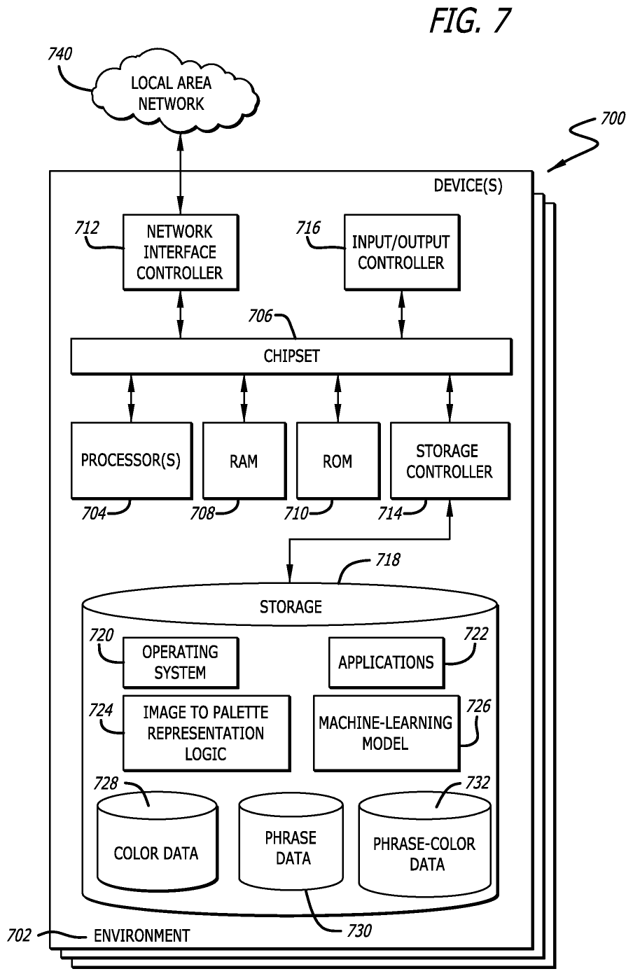

Referring to FIG. 7, a conceptual block diagram of a device suitable for configuration with a movement detection logic in accordance with various embodiments of the disclosure is shown. The embodiment of the conceptual block diagram depicted in FIG. 7 can illustrate a conventional server computer, workstation, desktop computer, laptop, tablet, network device, access point, router, switch, e-reader, smart phone, centralized management service, or other computing device, and can be utilized to execute any of the application and/or logic components presented herein. The device 700 may, in some examples, correspond to physical devices and/or to virtual resources and embodiments described herein.

In many embodiments, the device 700 may include an environment 702 such as a baseboard or “motherboard,” in physical embodiments that can be configured as a printed circuit board with a multitude of components or devices connected by way of a system bus or other electrical communication paths. Conceptually, in virtualized embodiments, the environment 702 may be a virtual environment that encompasses and executes the remaining components and resources of the device 700. In more embodiments, one or more processors 704, such as, but not limited to, central processing units (“CPUs”) can be configured to operate in conjunction with a chipset 706. The processor(s) 704 can be standard programmable CPUs that perform arithmetic and logical operations necessary for the operation of the device 700.

In additional embodiments, the processor(s) 704 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 706 may provide an interface between the processor(s) 704 and the remainder of the components and devices within the environment 702. The chipset 706 can provide an interface to communicatively couple a random-access memory (“RAM”) 708, which can be used as the main memory in the device 700 in some embodiments. The chipset 706 can further be configured to provide an interface to a computer-readable storage medium such as a read-only memory (“ROM”) 710 or non-volatile RAM (“NVRAM”) for storing basic routines that can help with various tasks such as, but not limited to, starting up the device 700 and/or transferring information between the various components and devices. The ROM 710 or NVRAM can also store other application components necessary for the operation of the device 700 in accordance with various embodiments described herein.

Different embodiments of the device 700 can be configured to operate in a networked environment using logical connections to remote computing devices and computer systems through a network, such as the network 740. The chipset 706 can include functionality for providing network connectivity through a network interface card (“NIC”) 712, which may comprise a gigabit Ethernet adapter or similar component. The NIC 712 can be capable of connecting the device 700 to other devices over the network 740. It is contemplated that multiple NICs 712 may be present in the device 700, connecting the device to other types of networks and remote systems.

In further embodiments, the device 700 can be connected to a storage 718 that provides non-volatile storage for data accessible by the device 700. The storage 718 can, for example, store an operating system 720, applications 722, and data 728, 730, 732, which are described in greater detail below. The storage 718 can be connected to the environment 702 through a storage controller 714 connected to the chipset 706. In certain embodiments, the storage 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 700 can store data within the storage 718 by transforming the physical state of the physical storage units to reflect the information being stored. The specific transformation of physical state can depend on various factors. Examples of such factors can include, but are not limited to, the technology used to implement the physical storage units, whether the storage 718 is characterized as primary or secondary storage, and the like.

For example, the device 700 can store information within the storage 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 700 can further read or access information from the storage 718 by detecting the physical states or characteristics of one or more particular locations within the physical storage units.

In addition to the storage 718 described above, the device 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 700. In some examples, the operations performed by a cloud computing network, and or any components included therein, may be supported by one or more devices similar to device 700. Stated otherwise, some or all of the operations performed by the cloud computing network, and or any components included therein, may be performed by one or more devices 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 718 can store an operating system 720 utilized to control the operation of the device 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 718 can store other system or application programs and data utilized by the device 700.

In various embodiment, the storage 718 or other computer-readable storage media is encoded with computer-executable instructions which, when loaded into the device 700, may transform it from a general-purpose computing system into a special-purpose computer capable of implementing the embodiments described herein. These computer-executable instructions may be stored as application 722 and transform the device 700 by specifying how the processor(s) 704 can transition between states, as described above. In some embodiments, the device 700 has access to computer-readable storage media storing computer-executable instructions which, when executed by the device 700, perform the various processes described above with regard to FIGS. 1-7. In more embodiments, the device 700 can also include computer-readable storage media having instructions stored thereupon for performing any of the other computer-implemented operations described herein.

In still further embodiments, the device 700 can also include one or more input/output controllers 716 for receiving and processing input from a number of input devices, such as a keyboard, a mouse, a touchpad, a touch screen, an electronic stylus, or other type of input device. Similarly, an input/output controller 716 can be configured to provide output to a display, such as a computer monitor, a flat panel display, a digital projector, a printer, or other type of output device. Those skilled in the art will recognize that the device 700 might not include all of the components shown in FIG. 7 and can include other components that are not explicitly shown in FIG. 7 or might utilize an architecture completely different than that shown in FIG. 7.

As described above, the device 700 may support a virtualization layer, such as one or more virtual resources executing on the device 700. In some examples, the virtualization layer may be supported by a hypervisor that provides one or more virtual machines running on the device 700 to perform functions described herein. The virtualization layer may generally support a virtual resource that performs at least a portion of the techniques described herein.

In many embodiments, the device 700 can include a phrase to palette representation logic 724 that can be configured to perform one or more of the various steps, processes, operations, and/or other methods that are described above. While the embodiment shown in FIG. 7 depicts a logic focused on network capacity, it is contemplated that a more general “network needs” logic may be utilized as well or in lieu of such logic. Often, the phrase to palette representation logic 724 can be a set of instructions stored within a non-volatile memory that, when executed by the controller(s)/processor(s) 704 can carry out these steps, etc. In some embodiments, the phrase to palette representation logic 724 may be a client application that resides on a network-connected device, such as, but not limited to, a server, switch, personal or mobile computing device in a single or distributed arrangement. In certain embodiments, the phrase to palette representation logic 724 can be a dedicated hardware device or be configured into a system on a chip package (FPGA, ASIC and the like).

In a number of embodiments, the storage 718 can include color data 728. As discussed above, the color data 728 can be collected in a variety of ways and may involve data related to multiple images. The color data 728 may be associated with an entire image or a portion/partition of an image. This may also include a relationship of the various associated images that are associated with each other. In additional embodiments, the color data 728 can include not only color-related data, but may also include details about the metadata, color-coding, device hardware configuration and/or capabilities of the devices within the image processing pipeline. This can allow for more reliable phrase and/or palette determinations.

In various embodiments, the storage 718 can include phrase data 730. As described above, phrase data 730 can be configured to include various adjectives, phrases, and other word combination as well as previously determined associations. The phrase data 730 may be formatted to store a range of values for each type of phrase. These phrases can be utilized to compare against current values or words. This phrase data 730 can be provided by a provider prior to deployment. However, system administrators may train or otherwise associate these values by utilizing feedback on correct and incorrect detected relationships.

In still more embodiments, the storage 718 can include phrase-color data 732. As discussed above, phrase-color data 732 can be utilized to verify the relationship between an phrase and a color. Likewise, by utilizing phrase-color data 732, the type of associations may be better discerned. Likewise, one or more palettes may be generated by utilizing the phrase-color data 732.

Finally, in many embodiments, data may be processed into a format usable by a machine-learning model 726 (e.g., feature vectors, etc.), and or other pre-processing techniques. The machine learning (“ML”) model 726 may be any type of ML model, such as supervised models, reinforcement models, and/or unsupervised models. The ML model 726 may include one or more of linear regression models, logistic regression models, decision trees, Naïve Bayes models, neural networks, k-means cluster models, random forest models, and/or other types of ML models 726. The ML model 726 may be configured to learn the pattern of historical movement data of various network devices and generate predictions and/or confidence levels regarding current anomalous movements. In some embodiments, the ML model 726 can be configured to determine various phrase and color relationships to generate a palette related to an image as well as parsing out various object and/or portions of the images.

The ML model(s) 726 can be configured to generate inferences to make predictions or draw conclusions from data. An inference can be considered the output of a process of applying a model to new data. This can occur by learning from at least the topology data, historical data, measurement data, profile data, neighboring device data, and/or the underlying algorithmic data and use that learning to predict future outcomes and needs. These predictions are based on patterns and relationships discovered within the data. To generate an inference, such as a determination on anomalous movement, the trained model can take input data and produce a prediction or a decision/determination. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 726 may be generated by human/administrator verifications or may compare predicted outcomes with actual outcomes. The training set of the ML model(s) 726 can be provided by the manufacturer prior to deployment and can be based on previously verified data.

Although a specific embodiment for a device suitable for configuration with a network capacity prediction logic suitable for carrying out the various steps, processes, methods, and operations described herein is discussed with respect to FIG. 7, any of a variety of systems and/or processes may be utilized in accordance with embodiments of the disclosure. For example, the device may be in a virtual environment such as a cloud-based network administration suite, or it may be distributed across a variety of network devices or APs such that each acts as a device and the phrase to palette representation logic 724 acts in tandem between the devices. The elements depicted in FIG. 7 may also be interchangeable with other elements of FIGS. 1-6 and 8 as required to realize a particularly desired embodiment.

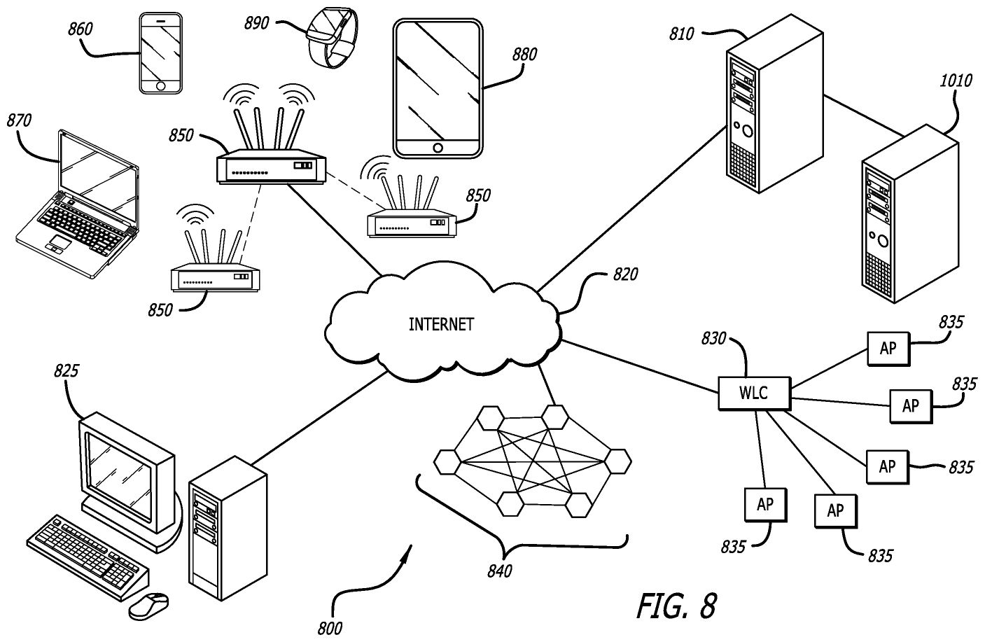

Referring to FIG. 8, a conceptual network diagram of various environments that a phrase to palette representation logic may operate within in accordance with various embodiments of the disclosure in accordance with various embodiments of the disclosure is shown. Those skilled in the art will recognize that a phrase to palette representation logic can be comprised of various hardware and/or software deployments and can be configured in a variety of ways. In some non-limiting examples, the phrase to palette representation logic can be configured as a standalone device, exist as a logic within another network device, be distributed among various network devices operating in tandem, or remotely operated as part of a cloud-based network management tool.

In many embodiments, the network 800 may comprise a plurality of devices that are configured to transmit and receive data for a plurality of clients. In various embodiments, cloud-based centralized management servers 810 are connected to a wide-area network such as, for example, the Internet 820. In further embodiments, cloud-based centralized management servers 810 can be configured with or otherwise operate a phrase to palette representation logic. The phrase to palette representation logic can be provided as a cloud-based service that can service remote networks, such as, but not limited to the deployed network 840. In these embodiments, the phrase to palette representation logic can be a logic that receives data from the deployed network 840 and generates predictions, receives environmental sensor signal data, and perhaps automates certain decisions or protective actions associated with the network devices. In certain embodiments, the phrase to palette representation logic can generate historical and/or algorithmic data in various embodiments and transmit that back to one or more network devices within the deployed network 840.

However, in additional embodiments, the phrase to palette representation logic may be operated as distributed logic across multiple network devices. In the embodiment depicted in FIG. 8, a plurality of network access points (APs) 850 can operate as a phrase to palette representation logic in a distributed manner or may have one specific device facilitate the detection of movement for the various APs. This can be done to provide sufficient needs to the network of APs such that, for example, a minimum bandwidth capacity may be available to various devices. These devices may include but are not limited to mobile computing devices including laptop computers 870, cellular phones 860, portable tablet computers 880 and wearable computing devices 890.

In still further embodiments, the phrase to palette representation logic may be integrated within another network device. In the embodiment depicted in FIG. 8, the wireless LAN controller 830 may have an integrated phrase to palette representation logic that it can use to generate predictions, and perhaps detect anomalous movements regarding the various APs 835 that it is connected to, either wired or wirelessly. In this way, the APs 835 can be configured such that they can process image and/or palette related data. In still more embodiments, a personal computer 825 may be utilized to access and/or manage various aspects of the phrase to palette representation logic, either remotely or within the network itself. In the embodiment depicted in FIG. 8, the personal computer 825 communicates over the Internet 820 and can access the phrase to palette representation logic within the cloud based centralized management servers 810, the network APs 850, or the WLC 830 to modify or otherwise monitor the phrase to palette representation logic.

Although a specific embodiment for a conceptual network diagram of a various environments that an phrase to palette representation logic operating on a plurality of network devices suitable for carrying out the various steps, processes, methods, and operations described herein is discussed with respect to FIG. 8, any of a variety of systems and/or processes may be utilized in accordance with embodiments of the disclosure. For example, the phrase to palette representation logic may be implemented across a variety of the systems described herein such that some detections are generated on a first system type (e.g., remotely), while additional detection steps or protection actions are generated or determined in a second system type (e.g., locally). The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each, and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a logic configured to:
receive a phrase;
generate a set of vectors associated with each identified words in the phrase;
calculate a first overall vector associated with the received phrase based on a vector summation of the generated set of vectors;
generate a palette for a set of colors comprising a predefined number of colors;
calculate a second overall vector associated with the palette based on a vector summation of the set of colors; and
in response to a first determination that a first closeness ratio associated with the generated palette is larger than a first predetermined threshold, store the generated palette, wherein the first closeness ratio is defined as an inverse of a difference between the calculated first overall vector and the calculated second overall vector.

2. The device of claim 1, wherein the logic is configured to display the generated palette to a user.

3. The device of claim 1, wherein the phrase is received from a user.

4. The device of claim 1, wherein the logic is configured to:
access portions of a color spectrum, wherein the accessed portions include data of colors that are visible to human eye; and
generate the palette for the set of colors comprising the predefined number of colors based on the accessed portions.

5. The device of claim 1, wherein the logic is configured to parse the received phrase to identify the words.

6. The device of claim 1, wherein a user selects the predefined number of colors.

7. The device of claim 1, wherein the logic is configured to:
access a database comprising pairs of colors and corresponding adjectives; and
determine an adjective for each of the set of colors of the generated palette.

8. The device of claim 1, wherein the logic is configured to:
receive a set of words;
assign a weight to each of the received words, wherein the assigned weight is a number between 0 and 1;
generate a second set of vectors associated with each of the received words;
calculate a set of weighted vectors by applying the assigned weight to the associated received word; and
calculate a third overall vector associated with the received set of words based on the vector summation of the calculated set of weighted vectors.

9. The device of claim 8, wherein the logic is configured to:
in response to a second determination that a second closeness ratio associated with the generated palette is larger than a second predetermined threshold, store the generated palette, wherein the second closeness ratio is defined as an inverse of a difference between the calculated second overall vector and the calculated third overall vector.

10. The device of claim 9, wherein a user selects the assigned weights.

11. The device of claim 1, wherein the logic includes one or more artificial intelligence models, and wherein the one or more artificial intelligence models include at least one of: a convolutional neural network, a region-based convolutional neural network, and a You Only Look Once neural network.

12. The device of claim 11, wherein the one or more artificial intelligence models are configured to at least: generate the set of vectors associated with each identified words in the phrase, calculate the first overall vector and the second overall vector, generate the palette for the set of colors comprising the predefined number of colors, and determine whether the closeness ratio associated with the generated palette is larger than the predetermined threshold.

13. A method, comprising:
receiving a phrase;
generating a set of vectors associated with each identified words in the phrase;
calculating a first overall vector associated with the received phrase based on a vector summation of the generated set of vectors;
generating a palette for a set of colors comprising a predefined number of colors;
calculating a second overall vector associated with the palette based on a vector summation of the set of colors; and
in response to a first determination that a first closeness ratio associated with the generated palette is larger than a first predetermined threshold, storing the generated palette, wherein the first closeness ratio is defined as an inverse of a difference between the calculated first overall vector and the calculated second overall vector.

14. The method of claim 13, further comprising:
accessing portions of a color spectrum, wherein the accessed portions include data of colors that are visible to human eye; and
generating the palette for the set of colors comprising the predefined number of colors based on the accessed portions.

15. The method of claim 13, further comprising parsing the received phrase to identify the words.

16. The method of claim 13, further comprising:
accessing a database comprising pairs of colors and corresponding adjectives; and
determining an adjective for each of the set of colors of the generated palette.

17. The method of claim 13, further comprising:
receiving a set of words;
assigning a weight to each of the received words, wherein the assigned weight is a number between 0 and 1;
generating a second set of vectors associated with each of the received words;
calculating a set of weighted vectors by applying the assigned weight to the associated received word; and
calculating a third overall vector associated with the received set of words based on the vector summation of the calculated set of weighted vectors.

18. The method of claim 17, further comprising:
in response to a second determination that a second closeness ratio associated with the generated palette is larger than a second predetermined threshold, storing the generated palette, wherein the second closeness ratio is defined as an inverse of a difference between the calculated second overall vector and the calculated third overall vector.

19. The method of claim 13, wherein one or more artificial intelligence models including at least one of: a convolutional neural network, a region-based convolutional neural network, and a You Only Look Once neural network are configured to perform at least: generating the set of vectors associated with each identified words in the phrase, calculating the first overall vector and the second overall vector, generating the palette for the set of colors comprising the predefined number of colors, and determining whether the closeness ratio associated with the generated palette is larger than the predetermined threshold.

20. A system, comprising:
one or more devices;
one or more processors coupled to the one or more devices; and
a non-transitory computer-readable storage medium for storing instructions that, when executed by the one or more processors, direct the one or more processors to:
receive a phrase;
generate a set of vectors associated with each identified words in the phrase;
calculate a first overall vector associated with the received phrase based on a vector summation of the generated set of vectors;
generate a palette for a set of colors comprising a predefined number of colors;
calculate a second overall vector associated with the palette based on a vector summation of the set of colors; and
in response to a first determination that a first closeness ratio associated with the generated palette is larger than a first predetermined threshold, store the generated palette, wherein the first closeness ratio is defined as an inverse of a difference between the calculated first overall vector and the calculated second overall vector.
